(19) United States
(12) Patent Application Publication
(10) Pub. No.: US 2014/0360101 A1
(43) Pub. Date: Dec. 11, 2014

(54) SEAL MEMBERS FOR THIN-PANEL SWINGING DOORS

(71) Applicant: Whiting Door Manufacturing Corporation, Akron, NY (US)

(72) Inventor: Donald J. Whiting, JR., Clarence, NY (US)

(73) Assignee: Whiting Door Manufacturing Corporation, Akron, NY (US)

(21) Appl. No.: 13/912,363

(22) Filed: Jun. 7, 2013

(51) Int. Cl. E06B 7/23

(52) U.S. Cl. CPC E06B 7/2312
USPC 49/490.1; 49/484.1

(57) ABSTRACT

A seal member (20) for selectively sealing the space between a thin swinging door panel (23L) and an adjacent structure (21L), includes: a U-shaped portion (33) adapted to embrace a marginal end portion of the panel adjacent the end face, having a web (34) arranged to face toward the panel end face, having a first and second legs (35, 37) extending away from the web; a boss or lug (53) extending outwardly from the U-shaped portion in a direction away from the proximate panel surface; a first seal lip (42) having proximal portion (43) extending outwardly from the boss or lug and away from the proximate leg, and a second seal lip (39) extending away from the web. The seal lips have a distal marginal end portions (41, 44) adapted to selectively engage portions of the adjacent structure when the door is moved to its closed position.

### TECHNICAL FIELD

The present invention relates to swinging doors, such as commonly used on truck- and trailer-mounted cargo bodies, and, more particularly, to improved seal members for use with thin-panel swinging doors.

### BACKGROUND ART

Swinging door(s) are found on a myriad of different structures. Some of these structures are movable (e.g., when provided on truck- and trailer-mounted cargo bodies), while others are provided on static structures (e.g., on warehouses, and the like).

In general, such swinging door(s) are positioned for pivotal movement on hinges mounted on a jamb, and are adapted to be selectively moved between opened and closed positions. When the door(s) are in their opened position(s), access may be had to a protected space. However, when the door(s) are in their closed positions, access to the protected space is denied, and the closed door(s) provide a barrier between outside conditions and conditions within the protected space.

Truck- and trailer-mounted swinging door(s) pose special problems because of road vibrations and various loads when the vehicle moves. A typical two-panel trailer-mounted swinging door may be appear to be mounted on a substantially-rectangular perimeter frame (e.g., including the two spaced jambs, the header and the sill) when the vehicle is stationary. However, when the trailer is moved over a road, vibrations and various loads may distort the frame to parallelogram-like shapes on either side of a neutral position, approximated by the rectangular frame. This movement varies the spacing between the panel edges and adjacent structure.

It is generally desirable to reduce the weight of such vehicle-mounted cargo bodies. Hence, there is some pressure on door manufacturers to reduce the thickness of the swinging door panels to save weight. However, the spacing between a marginal edge of a door panel and adjacent structure will be unaffected if the thickness of the door panel is simply reduced.

Prior art swinging door(s) were provided with a seal member having a U-shaped portion that embraced a marginal end portion of a panel, and having two sealing lips that were adapted to engage adjacent structure (e.g., a jamb, an adjacent panel, etc.) when the door(s) were closed. See, e.g., U.S. Pat. No. 3,518,792, the aggregate disclosure of which is hereby incorporated by reference.

While these prior art seal members were appropriately sized to fit a thick-panel door (e.g., having a thickness of about ¾ inch), special problems would arise if one were to simply downsize the entire seal member to accommodate a thinner door panel (e.g., having a thickness of about ⅜ inch). For example, the sealing lips of a proportionally-downsized seal member might not be of sufficient length to sealingly engage the adjacent structure when the door was closed and/or the sealing lips of such a proportionally-downsized seal member might actually interfere with one another when the door was closed. This too could adversely affect the integrity of the seals with the adjacent structure.

Accordingly, there is a need for an improved seal member that can effectively seal the traditional space between a marginal edge of a thin-panel door and an adjacent structure.

### DISCLOSURE OF THE INVENTION

With parenthetical reference to the corresponding parts, portions or surfaces of the disclosed embodiment, merely for purposes of illustration and not by way of limitation, the present invention provides an improved seal member (26, 28) for selectively sealing the space between a thin-panel swinging door and an adjacent structure (21L, 21R, 26, 28). The door includes a panel (23L, 23R) having an inner surface (29L, 29R), an outer surface (30L, 30R) and an end face (31L, 31R, 32L, 32R) joining adjacent marginal end portions of the panel surfaces. The door is adapted to be moved between an opened position and a closed position.

The improved seal member broadly comprises: a U-shaped portion (33) adapted to embrace a marginal end portion of the panel adjacent the end face (31L, 31R, 32L, 32R), the U-shaped portion having a web (34) arranged to face toward the panel end face (31L, 31R, 32L, 32R, having a first leg (35) extending away from one end of the web and having a first surface (36) arranged to face toward one of the panel surfaces, and having a second leg (37) extending away from another end of the web and having a second surface (38) arranged to face toward the other of the panel surfaces; a boss or lug (53) extending outwardly from the U-shaped portion in a direction away from the proximate panel surface; and a first seal lip (42) having a proximal portion (43) extending outwardly from the boss or lug and away from the proximate leg, the first seal lip having a distal marginal end portion (44) adapted to selectively engage a portion of the adjacent structure when the door is moved to its closed position.

The improved seal member may further include: a second seal lip (39) having a proximal portion (40) extending away from the web and away from the proximate leg, the second seal lip having a distal marginal end portion (41) adapted to selectively engage a portion of the adjacent structure when the door is moved to its closed position.

The spacing between the proximal portions (40, 41) of the seal lips may be greater than the spacing between the panel inner and outer surfaces (i.e., dimension T₂).

The U-shaped portion (33) and the first and second seal lips (39, 42) may be formed integrally.

The U-shaped portion may have a hardness of one value, and the first and second lips may have a hardness of another value.

The seal lips may be so dimensioned and proportioned that the seal lips do not interfere with one another when the door is moved to the closed position.

The adjacent structure may be a jamb, and adjacent door panel, or some other structure.

The distal marginal end portions of the seal lips may engage the adjacent structure at spaced locations to provide spaced seals.

In one preferred embodiment, each of the seals provides a substantially water-tight seal between the panel and the adjacent structure when the door is moved to its closed position.

Accordingly, the general object of the invention is to provide an improved seal member.

Another object is to provide an improved seal member for use with thin-panel swinging doors.

These and other objects and advantages will become apparent from the foregoing and ongoing written specification, the drawings and the appended claims.

### BRIEF DESCRIPTION OF THE DRAWINGS

FIG. 1A is a schematic fragmentary horizontal view, partly in section and partly in elevation, of prior art seal members in use with thick-panel swinging doors.

FIG. 1B is an enlarged view of one of the seal members shown in FIG. 1A.

FIG. 1C is an enlarged view of another of the seal members shown in FIG. 1A.

FIG. 2A is a schematic fragmentary horizontal view, partly in section and partly in elevation, showing a hypothetical proportionally-downsized modification of the prior art seal members shown in FIG. 1A to thin-panel swinging doors.

FIG. 2B is an enlarged view of one of the hypothetically-modified seal members shown in FIG. 2A.

FIG. 2C is an enlarged view of another of the hypothetically-modified seal members shown in FIG. 2A.

FIG. 2D is a schematic fragmentary horizontal view, partly in section and partly in elevation, of the hypothetically-modified structure shown in FIG. 2A, but with a reduced dimension D₂, and illustrates one seal lip interfering with the other seal lip when the door is closed.

FIG. 3A is a schematic fragmentary horizontal view, partly in section and partly in elevation, of one form of the inventive seal members mounted on thin-panel swinging doors.

FIG. 3B is an enlarged view of one of the inventive seal members shown in FIG. 3A.

FIG. 3C is an enlarged view of another of the inventive seal members shown in FIG. 3A.

### DISCLOSURE OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

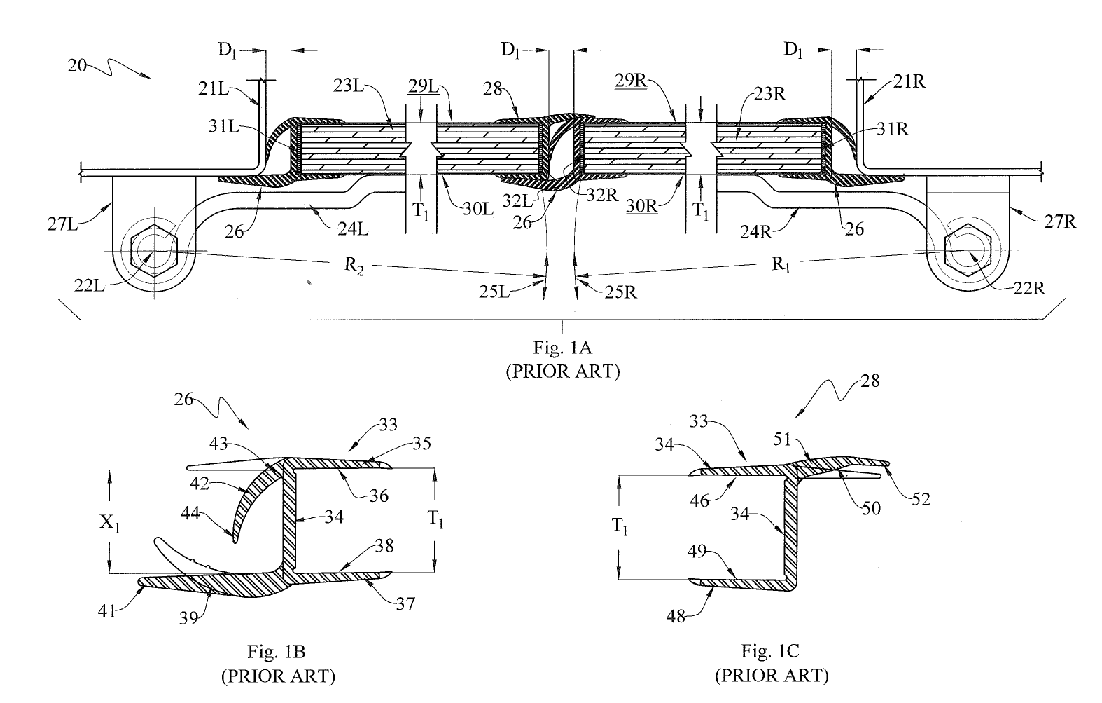

### Prior Art Door Seals (FIGS. 1A-1C)

Referring now to the drawings, and more particularly, to FIGS. 1A-1C, a prior art swinging door, generally indicated at 20, is shown as being mounted on the cargo-carrying body of a truck or trailer. More particularly, the body has a pair of horizontally-spaced jambs, severally indicated at 21L, 21R, provided on either side of an access opening. This door is generally similar to that shown and described in U.S. Pat. No. 3,518,792.

A bracket 27L, 27R extends downwardly (i.e., outwardly) from the outer surface of each jamb to receive and accommodate a pivot pin 22L, 22R having a polygonal head. The door has a left panel 23L and a right panel 23R. The left panel is pivotally mounted on the pivot pin 22L by means of a hinge section 24L, and the right door panel 23R is pivotally mounted on the right pivot pin 22R by means of a hinge section 24R. These two panels 23L, 23R are substantially rectangular when seen in elevation (not shown). The two panels are mounted for swinging motion between an opened position (not shown) and a closed position, as depicted in FIG. 1A. The directions of swinging motion of panels 23L, 23R are depicted by double-headed arrows 25L, 25R respectively.

This prior art arrangement was shown as having two types of seal members, generally indicated at 26, 28, respectively. An enlarged-scale version of seal member 26 is depicted in FIG. 1B and an enlarged-scale version of seal member 28 is depicted in FIG. 1C. These two seal members, either alone, or in combination with one another, were operatively arranged to selectively seal the space between the swinging door and adjacent structure. As best shown in FIG. 1A, when the door is closed, the space between left seal member 26 and left jamb 21L is depicted as having a horizontal dimension D₁. Similarly, at the right side, the dimension between right seal member 26 and right jamb 21R is also indicated as having a horizontal dimension D₁. At the middle of the door, the space between the webs of the two seal members 26, 28, is also shown as being of horizontal dimension D₁. If the door panel had a thickness (T₁) of, say, ¾ inch, then dimension D₁ might be on the order of ⅜ inch. This simply expresses the order of magnitude of dimension D₁, and the three dimensions, severally indicated at D₁, in FIG. 1A, may be the same, or may be slightly different from one another.

Each panel has an inner surface and an outer surface. Thus, the left panel 23L has an inner surface 29L and an outer surface 30L. Similarly, the right panel 23R has an inner surface 29R and an outer surface 30R.

In FIG. 1A, left panel 23L is shown as having a left end face 31L and a right end face 32L. Conversely, the right panel 23R is shown as having a right end face 31R and left end face 32R. Thus, panel end faces 31 are arranged to face toward the proximate jamb, and panel end faces 32 are arranged to face toward one another. The left panel end face 32L is mounted for swinging motion about pivot pin 22L at a radius R₂, and the right panel end face 32R is mounted for swinging motion about pivot pin 22R at a radius R₁.

Adverting now to FIG. 1B, this seal member is shown as having a U-shaped portion 33 adapted to embrace a marginal end portion of the associated panel adjacent its proximate end face. This U-shaped portion has a web 34 arranged to face toward the panel end face, has a first leg 35 having a first surface 36 arranged to face toward one of the panel inner and outer surfaces, and has a second leg 37 extending away from the web and having a second surface 38 arranged to face toward the other of the panel inner and outer surfaces.

A first seal lip, indicated at 39, has a proximal portion 40 extending away from the one marginal end of the web 34, and has a distal marginal end portion 41 adapted to selectively engage a portion of the adjacent structure (i.e., the jamb or the other seal member) when the door is in its closed position. This arrangement also has a second seal lip, indicated at 42, having a proximal portion 43 extending away from the other marginal end portion of the web, and has a distal marginal end portion 44 operatively arranged to selectively engage a portion of adjacent structure (i.e., either the proximate jamb or seal member) when the door is in its closed position.

FIG. 1B illustrates, in section, the positions of the first and second seal lips when the door is in its closed position and indicates in outline, the positions of the first and second seal members when the door is in its opened position.

Referring now to FIG. 1C, complimentary seal member 28 is also shown as having a web 34 provided with a first leg 45 having a surface 46 extending away from the web and arranged to face one of the panel inner and outer surfaces, and having a second leg 48 extending away from the other marginal end portion of the web, and having a surface 49 arranged to face toward the other of the panel inner and outer surfaces. This embodiment also has a seal lip, indicated at 50, having a proximal portion 51 extending away from one marginal end portion of the web, and having a distal marginal end portion 52 arranged to engage a portion of adjacent structure (i.e., either the proximate jamb or other seal member) when the door is moved toward a closed position.

In FIGS. 1B and 1C, the dimension between facing seal member surfaces 36, 38 is indicated by dimension T₁, which is substantially equal to the thickness (T₁) of the panel shown in FIG. 1A. The dimension between the proximal portions of the first and second seal members is indicated by dimension X₁.

Thus, when the doors of the prior art arrangement shown in FIGS. 1A-1C were moved from their opened positions to their closed positions, the lips of the left seal member 26 would sealingly engage the left door jamb 21L. Conversely, the lips of the right seal member 26 would sealingly engage right door jamb 21R. At the middle of the door, the sealing lips 39, 42 of seal member 26 would engage the facing proximate surfaces of seal member 28.

The arrangement shown in FIGS. 1A-1C worked acceptably well for relatively thick door panels having a thickness of about ¾ inch. However, there is an increasing desire to reduce the weight of the doors, and, hence, the door panels. This might be done by reducing the thickness of the door panels. However, a simple reduction of the thickness of the panels would not affect the spacing between the panels and the jamb, or the spacing between the distal ends of the panels.

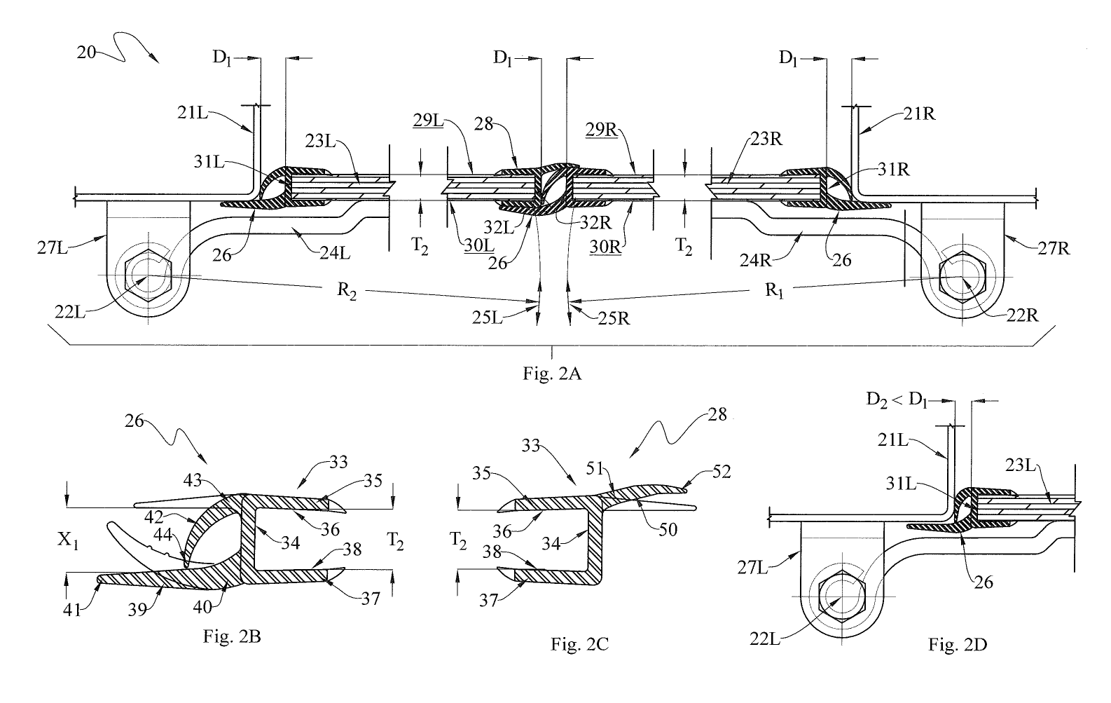

### Hypothetically-Modified Door Seals (FIGS. 2A-2D)

FIGS. 2A-2D illustrate a hypothetically-modified arrangement in which the seal members are proportionally reduce in size and scale to accommodate a thinner door panel having a reduced thickness T₂. Since much of the structure is common to that previously described, the same reference numerals sued before will again be applied to the corresponding structure shown in FIGS. 2A-2D.

Whereas the panels in FIG. 1A were relatively thick, as indicated by dimension T₁, the door panels shown in FIG. 2A are substantially thinner, and are represented by dimension T₂. Upon information and belief, the hypothetically-modified structure shown in FIGS. 2A-2D is not prior art. However, it is included as showing the structure that might result if the entire seal member, or just the U-shaped portion thereof, were to be proportionally reduced in size and scale to accommodate a thinner door panel.

To accommodate such thinner panels, one would think that it would be immediately apparent to proportionally reduce the size of each seal member. Thus, while the same general numbering has been retained in FIGS. 2A-2D, the distance between seal member surfaces 36, 38 is represented by dimension T₂, which is substantially equal to the thickness T₂ of each panel.

However, if the seal lips and the U-shaped portion of each seal member were also proportionally reduced, then at least one of two possible problems might occur. First, if the seal lips were proportionally reduced in size and dimension, they might not adequately contact the proximate adjacent structure (i.e., the jamb, or the web of the adjacent seal member). Alternatively, if only the U-shaped portion was reduced in size, and the seal lips remained substantially the same size, then the distal end of the shorter lip might strike the inner surface of the longer lip, and interfere with the integrity of the seals, as shown in FIG. 2D. This drawing figure also indicates that the dimension between the panel end and the proximate jamb is dimension D₂, which is less than dimension D₁. Thus, the logical way to accommodate a thinner door panel would be to proportionally shrink the dimensions of the seal member. If the dimension of the seal lips was also reduced, then the integrity of the seals might be adversely affected. Alternatively, if the seal lips were of the same dimension as shown in the prior art arrangement depicted in FIGS. 1A-1C, then the seal lips might interfere with one another when the door is closed and this could adversely affect the sealing integrity of the two spaced seals.

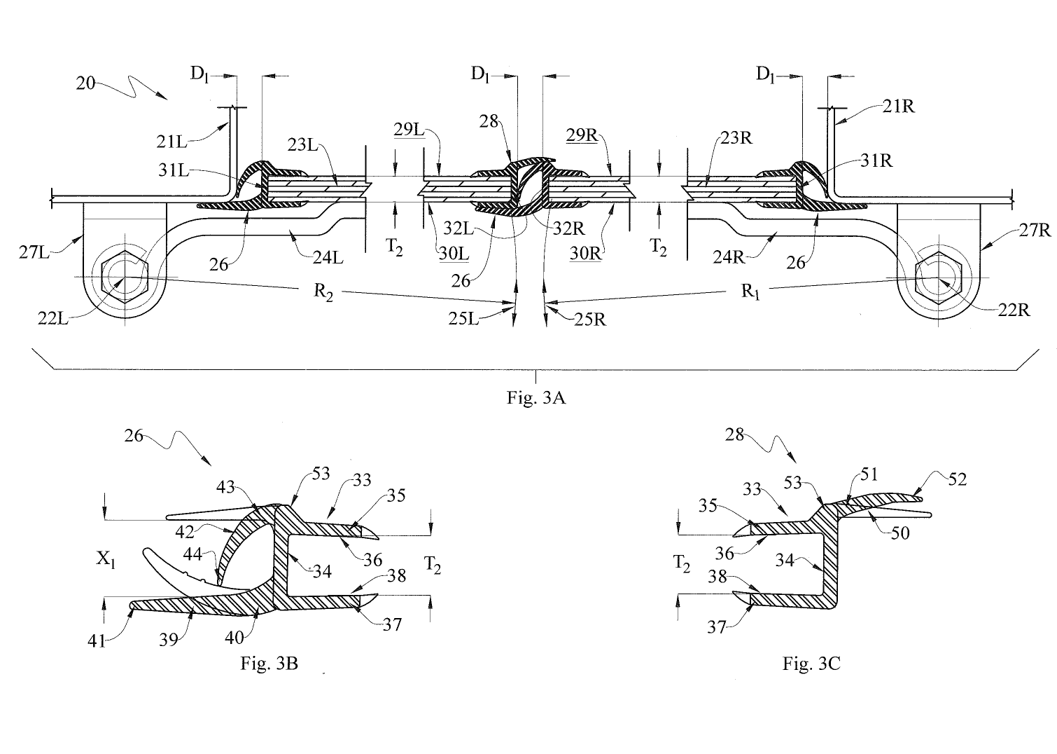

### Improved Door Seals (FIGS. 3A-3C)

FIGS. 3A-3C illustrate improved door seals. Since much of the structure is common to that previously described, the same reference numerals used before will be again applied to the corresponding structure shown in FIGS. 3A-3B.

The salient difference in the improved seal member is that a boss or lug 53 extends outwardly from one marginal end portion of web 34, and the proximate seal lip is mounted on the boss or lug, rather than on the web. Thus, the U-shaped portion 33 of each improved seal member is proportionally reduced, as shown in FIG. 3B, to accommodate the thinner door panel of thickness T₂. However, the effect of boss or lug 53 is to extend the dimension X₁, to equal the dimension X₁ in FIG. 1A, so that the seal lips 39, 42 may be substantially the same size and configuration as in the prior art arrangement shown in FIG. 1A. The salient difference is the improved arrangement has a boss or lug 53 extending away from the joint between the web and one of the legs, and the first seal lip extends away from the boss or lug rather than the web itself. Thus, the improved seal member has a U-shaped portion that is proportionally reduced so as to accommodate the thinner door panel, but has one or more sealing lips that are of substantially the same size and configuration as in the prior art arrangement. Those enlarged seal lips have been found to be adequate to close dimension D₁, and to not interfere with one another when the door is closed.

Therefore, the present invention broadly provides an improved seal member 20 for selectively sealing the space D₁ between a swinging door and an adjacent structure. The door includes a panel 23L having an inner surface 29L, an outer surface 30L and an end face 32L joining adjacent marginal end faces of the panel surfaces. The door is adapted to be moved between an opened position and a closed position. The improved seal member includes a U-shaped portion 33 adapted to embrace a marginal end portion of the panel adjacent an end face. The U-shaped portion has a web 34 arranged to face toward the panel end face 32L, has a first leg 35 extending away from one marginal end of the web, and has a first surface 36 arranged to face toward one of the panel surfaces. A second leg 37 extends away from the other marginal end portion of the web and has a second surface 38 arranged to face toward the other of the panel surfaces. A boss or lug 53 extends outwardly from the U-shaped portion 33 in a direction away from the proximate panel surface. A first seal lip 42 has a proximal portion 43 extending outwardly from the boss or lug and away from the proximate leg. The first seal lip has a distal marginal end portion 44 adapted to selectively engage a portion of the adjacent structure when the door is moved from its opened position to its closed position.

The improved seal member may include a second seal lip 39 having a proximal portion 40 extending away from the other marginal end portion of the web and away from the proximate leg. This second seal lip may have a distal marginal end portion 41 adapted to selectively engage a portion of the adjacent structure when the door is closed. The spacing X₁ between the proximal portions of the seal lips is greater than the spacing T₁ between the panel inner and outer surfaces. The U-shaped portion and the first and/or second seal lips may be formed integrally of a suitable elastomeric material. In one form, the U-shaped portion may have a hardness of one value, and the first and/or second seal lips may have a hardness of a second value. The hardness of the seal lips may be the same or may be different, as desired. Thus, in this arrangement, the seal member is formed of a dual-durometer elastomeric material.

In one embodiment, the seal member may be formed of a suitable polyvinyl chloride material. The U-shaped portion thereof may have a hardness of about 78 on a Shore D scale, and the sealing lip(s) thereof may have a hardness of about 654 on a Shore A scale. However, this material and these hardness values are merely exemplary, and are not limitative of the scope of the appended claims.

### Modifications

The present invention expressly contemplates that many changes and modifications may be made. For example, while it is presently preferred that the seal members be made of elastomeric material great variation in the selection of type of material is afforded. Secondly, while the preferred arrangement used as a dual-durometer elastomeric material, this is not invariable, and may be changed. The adjacent structure may be a proximate door jamb, or it may be a portion of a proximate other seal member.

The two seal members are operatively arranged to engage such adjacent structure to provide a spaced substantially water-tight seals.

While the present invention is deemed particularly useful for use on cargo-carrying vehicle bodies and trailers, the improved seal members may be used on static structures as well.

Therefore, while preferred forms of the improved seal members have been shown and described, and several modifications and changes thereof discussed, persons skilled in this art will readily appreciated the various additional changes and modification may be made without departing from the spirit of the invention, as defined and differentiated by the following claims.

What is claimed is:

1. A seal member for selectively sealing the space between a swinging door and an adjacent structure, said door including a panel having an inner surface, an outer surface and an end face joining adjacent marginal end portions of said panel surfaces, said door being adapted to be moved between an opened position and a closed position, comprising:
a U-shaped portion adapted to embrace a marginal end portion of said panel adjacent said end face, said U-shaped portion having a web arranged to face toward said panel end face, having a first leg extending away from one end of said web and having a first surface arranged to face toward one of said panel surfaces, and having a second leg extending away from another end of said web and having a second surface arranged to face toward the other of said panel surfaces;
a boss extending outwardly from said U-shaped portion in a direction away from the proximate panel surface; and
a first seal lip having a proximal portion extending outwardly from said boss and away from the proximate leg, said first seal lip having a distal marginal end portion adapted to selectively engage a portion of said adjacent structure when said door is moved to its closed position.

2. A seal member as set forth in claim 1, and further comprising:
a second seal lip having a proximal portion extending away from said web and away from the proximate leg, said second seal lip having a distal marginal end portion adapted to selectively engage a portion of said adjacent structure when said door is moved to its closed position.

3. A seal member as set forth in claim 2 wherein the spacing between the proximal portions of said seal lips is greater than the spacing between said panel inner and outer surfaces.

4. A seal member as set forth in claim 3 wherein said U-shaped portion and said first and second seal lips are formed integrally.

5. A seal member as set forth in claim 4 wherein said U-shaped portion has a hardness of one value, and said first and second lips have a hardness of another value.

6. A seal member as set forth in claim 2 wherein said seal lips are so dimensioned and proportioned that said seal lips do not interfere with one another when said door is moved to said closed position.

7. A seal member as set forth in claim 1 wherein said adjacent structure is a jamb.

8. A seal member as set forth in claim 1 wherein said adjacent structure is an adjacent swinging door panel.

9. A seal member as set forth in claim 2 wherein the distal marginal end portions of said seal lips engage said adjacent structure at spaced locations to provide spaced seals.

10. A seal member as set forth in claim 9 wherein each of said seals provides a substantially water-tight seal between said panel and said adjacent structure when said door is moved to its closed position.
